(19) United States
(12) Patent Application Publication
(10) Pub. No.: US 2008/0313676 A1
(43) Pub. Date: Dec. 18, 2008

(54) METHOD AND DEVICE FOR SHARING PERSONALIZED SERVICES, PARTICULARLY FOR INTERACTIVE TELEVISION

(75) Inventors: Erwan BAYNAUD, Paris (FR); Gerard Delegue, Cachan (FR); Emmanuel Marilly, Saint-Michel-Sur-Orge (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/133,131

(22) Filed: Jun. 4, 2008

(30) Foreign Application Priority Data
Jun. 15, 2007 (FR) 0704254

(51) Int. Cl. G06F 13/00

(52) U.S. Cl. 725/50

(57) ABSTRACT

A method for sharing at least one service, in particular in interactive television service, between a source device and target communication terminal, said method comprising the following steps: receiving generic electronic service guide data, said generic data originating from a digital distribution network; receiving data specific to the user profile, said specific data originating from a peer-to-peer network connection; encrypting the generic and specific data and updating the electronic service guide of the source device; selecting a target communication terminal; selecting at least one service to transmit to said terminal; identifying fragments or pieces of fragments of the source device's electronic service guide corresponding to the service to be transmitted to the target communication terminal; transmitting the fragments or pieces of fragments of the source device's electronic service guide to target terminal, said fragments being at least partially personalized; and updating the target terminal's electronic service guide.

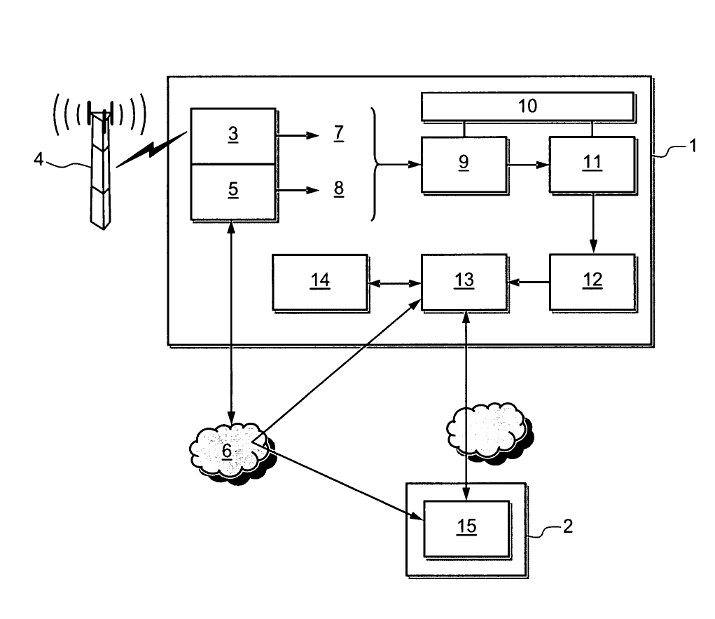

The invention pertains to the general technical field of distributing and receiving multimedia applications, and more particularly, a method for browsing and selecting services or audiovisual programs.

Here, the term “multimedia” refers to the interactive and simultaneous usage of multiple modes for representing information (text, still or moving images, sound).

The Internet, landline and mobile telephony, radio, and television are now available on computers using a single “multifunction” modem. The convergence of audiovisual media, computing, and telecommunications is reality for owners of these modems.

Interactive multimedia on mobile terminals is also causing a great deal of interest: MPEG4-BIFS, MPEG-LASeR (Lightweight Application Scene Representation, promoted by Streamezzo), SVG (Scalable Vector Graphics, promoted by the W3C, or World Wide Web Consortium), and MORE (Mobile Open Rich-Media Environment, promoted by the corporation Nokia).

The swelling number of channels and services has caused users to be confronted with an increasingly complicated choice.

Means are implemented in order to enable users to “browse” and make a selection from among the programs and services offered to them.

These means are commonly termed electronic program guides (EPGs) and electronic service guides (ESGs).

These guides are software applications that may be used in either a digital or analog environment.

An EPG is a self-contained service that offers interactive television among other services: VoD (Video on Demand), podcasts, PVR (Personal Video Recording), polls, trivia, and shopping. Here, the term “interactive television” (ITV) refers to any technology that makes it possible to communicate in both directions between viewers and service providers (such as broadcasters or cable operators), particularly for entertainment, information, education, or business.

Consumers of telecommunications services are faced with a multitude of combined service offerings: voice-Internet-television broadband packages (also known as “triple play” packages), 3G portal services, and television on mobile terminals.

This has resulted in a growing complexity in how the services are used, which has been further accentuated by the proliferation of existing terminals and networks that can carry these services.

For example, a video may be streamed from an Internet server onto a PC terminal, or sent by cable to a television screen, or multicast on a 3G network of mobile communication terminals.

This has caused profiling to become a critical feature for service providers and operators, as a better understanding of consumer behavior makes it possible to increase the value of service infrastructures (such as 3G portals), by providing better-targeted, more personalized services.

This personalization is done by building a profile of the service's user. This may be done in an explicit, implicit, or supervised manner. In explicit profile building, the information is provided directly by the user. This information may be entered by the user, or obtained automatically by the system. Implicitly building a user profile relies on a method of inferring the background and preferences of the user from the behavior he exhibits when using the services. This implicit building traditionally implements Bayesian inference, neural nets, or genetic algorithms. Supervised building asks the consumer how satisfied he is with each response generated by the service provider.

For telecommunications service platforms, the company Siemens offers a product known as Service Delivery Manager tSM (tango SM) for broadband services. Nokia Technology Platform has developed software for Nokia S60 smartphones, which allow usage data to be collated (40 to 80 kB/month/user). Based on a group of volunteer users, data mining has made it possible to create profiles of users and usages (see Hannu Verkasalo, Handset-Based Monitoring of Mobile Customer Behavior).

Platforms offering services to mobile terminals take into account the small size of these devices' screens, as personalizing the way in which information is displayed, and personalizing the information itself, make it possible to limit the effort and time spent looking for this information

Therefore, it has been suggested that, in order to implement profiling, the characteristics of the user's communication terminal should be taken into account.

In this manner, for example, the applicant's document FR2792484 describes a personalized communication network. A server contains information about the users (personalities, habits) and their terminals (graphical interface characteristics, audio interface characteristics, processor clock speed). The user data is loaded ahead of time or provided online. A user interface is built based on the user's request, with this interface containing only objects or applications that are suitable for the user's terminal.

Taking the characteristics of the user's terminal into account for building his profile is advantageous in terms of usability, such as for television on mobile terminals.

However, doing so leads the following difficulties.

First, the user profile, as recorded on his mobile terminal, will generally not be the same as the one recorded for his television set. This difference in profiles may prevent the user from being able to access the same interactive services, regardless of which terminals is used.

Second, this difference in profiles may reduce interactivity within a virtual community. A user would find it hard to accept not being able to have the same level of interactivity as his friends, as a result of a difference in profiles. For example, the applicant has developed an interactive television technology known as AmigoTV, which allows the user to share opinions and feelings within a community. When multiple friends watch the same television program, they can, by using AmigoTV, comment to one another about it live. Their voices travel over the Internet, and six people can communicate at once. AmigoTV can also be used to send images and sounds selected from a catalog, to illustrate one's mood when reacting to a televised event.

This invention is therefore intended to provide means for enabling the user to enjoy an optimal number of services from a second terminal, in particular a mobile terminal, which are accessible to the user on a first terminal.

For this purpose, the invention, in a first aspect, pertains to a method for sharing at least one service, in particular an interactive television service, between a source device and a target communication terminal, said method comprising the following steps:

receiving generic electronic service guide data at the source device, said generic data originating from a digital distribution network;

receiving data specific to the user profile at the source device, said specific data originating from a peer-to-peer network connection;

decrypting the generic and specific data and updating the electronic service guide of the source device;

selecting a target communication terminal;

selecting at least one service to be transmitted to set target communication terminals;

identifying fragments or elements of fragments of the source device's service guide corresponding to the service to be transmitted to the target communication terminal;

transmitting fragments of the source device's electronic service guide to target communication terminal, said fragments being at least partially personalized, as they are derived from data specific to the source device's user profile;

updating the electronic service guide of the target communication terminal.

Advantageously, the method includes a step of selecting the services which one wants to send to the target terminal, and a step a filtering out, from among said services, those which cannot be transmitted due to a lack of access privileges.

The invention, in a second aspect, pertains to a source terminal equipped with a device for sharing at least one service, in particular a personalized interactive television service, with a target communication terminal, said sharing device comprising:

means for receiving generic electronic service guide data, said generic data originating from a digital distribution network;

means for received a data specific to the user profile, said specific data originating from a peer-to-peer network connection;

means for decrypting the generic and specific data and updating the source device's electronic service guide;

means for selecting a target communication terminal;

means for selecting at least one service to be transmitted to said target communication terminal;

means for identifying fragments or elements of fragments of the source device's electronic service guide corresponding to the service to be transmitted to the target communication terminal;

means for transmitting fragments of the source device's electronic service guide to target communication terminal, said fragments being at least partially personalized, as they are derived from data specific to the source device's user profile.

Advantageously, this terminal is a mobile communication terminal.

Other subjects and advantages of the invention will become apparent by reviewing the following description of embodiments, which makes reference to the attached single FIGURE.

The source device 1 is advantageously a mobile communication terminal.

The target terminal 2 may be a mobile telephone, a television receiver equipped with a decoder, a television receiver equipped with WiFi or Bluetooth connection, or personal computer.

The source device is equipped with a set of means, which will now be introduced.

First, the source device 1 comprises means for receiving 3 generic electronic service guide data, said generic data originating from a digital distribution network 4 such as DVB-H, DVB-H+, or DMB-S.

The source device 1 further comprises means for receiving 5 specific ESG data, said specific data depending on the user profile of the source device 1, said data originating from a peer-to-peer network 6.

Receiving generic and specific ESG data comprises three phases: identifying the ESGs available, acquiring the ESG fragments, and updating. One syntax for ESG data is found in the document EP 1791280 for the European digital television standard DVB.

Based on the generic data 7 and personalized data 8 that is received, an updated electronic service guide is obtained. The updating may be done through modulated transmission of data frames over a carrier, along a carousel or endless loop.

A browser 9 enables the user of the source device 1 to consult the services being offered, such as television program tie-ins, and to access these services.

This browser 9 is advantageously connected to a rights management module 10. In this manner, the user of the source device 1 is informed of whether or not he can share a particular service.

A first selection module 11 enables the user to choose the service(s) that he wishes to transmit to the target terminal 2.

A second selection module 12 enables the user to choose the target terminal 2, as well as the transmission protocol, such as Bluetooth, WiFi, GPRS, or UMTS. Depending on the protocol selected, the user must, if applicable, provide an identifier, such as a telephone number.

A sending module 13 sends the ESG fragments that correspond to the selected service(s) to the chosen target terminal.

Advantageously, the source device 1 comprises a service adaptation module 14. This module 14 is used to adapt the chosen service to the capabilities of the target terminal, such as its screen resolution.

The electronic service guide of the target terminal is updated by a module 15.

The implementation of the invention has numerous advantages.

A mobile terminal user will be able to continue using a service when he returns home, simply by using his television set as the target terminal.

All members of a community can enjoy the use of a service if one of its members wishes to share the experience with the other members of the community (which may include discussion groups, forums, interactive television services such as AmigoTV or myOwnTV, or virtual worlds such as Second Life).

1. A method for sharing at least one service, in particular an interactive television service, between a source device (1) and a target communication terminal (2) which are both equipped with an electronic service guide (ESG), said method comprising the following steps:
receiving, at the source device (1):
generic ESG data originating from a digital distribution network (4);
data specific to the user profile of the source device (1) originating from a peer-to-peer network connection (6);
updating the source device's ESG (1) based on the generic and specific data;
selecting a target communication terminal (2) equipped with an ESG;
selecting at least one service to be transmitted to said target communication terminals; (2);
identifying fragments or pieces of fragments of the source device's ESG (1) that correspond to the service to be transmitted to the target communication terminal (2);
transmitting the fragments of the source device's ESG (1) to the target communication terminal (2), said fragments or pieces of fragments being at least partially personalized, as they are derived from data specific to the source device's user profile (1);
updating the target communication terminal's ESG (2).

2. A method according to claim 1, characterized in that it comprises:
a step of selecting services that one wishes to transmit to the target terminal and
a step of filtering out, from among said services, those which cannot be transmitted due to a lack of access privileges.

3. A source terminal (1) equipped with an electronic service guide (ESG) and a device for sharing at least one service, in particular a personalized interactive television service, with a target communication terminal (2), said sharing device comprising:
means for receiving (3) generic ESG data originating from a digital distribution network (4);
means for receiving (5) data specific to the user profile originating from a peer-to-peer network connection (6);
means for updating the ESG of the source device (1);
means for selecting a target communication terminal (2);
means for selecting at least one service to be transmitted to said target communication terminal (2);
means for identifying fragments or pieces of fragments of the source device's ESG (1) that correspond to the service to be transmitted to the target communication terminal (2);
means for transmitting fragments of the source device's ESG (1) to the target communication terminal (2), said fragments being at least partially personalized, as they are derived from data specific to the source device's user profile.

4. A source terminal according to claim 3, said terminal being a mobile communication terminal.
